(19) United States
(12) Patent Application Publication
(10) Pub. No.: US 2023/0216994 A1
(43) Pub. Date: Jul. 6, 2023

(54) PROJECTION DISPLAY APPARATUS

(71) Applicant: SONY GROUP CORPORATION, TOKYO (JP)

(72) Inventor: TAKEAKI HIRASAWA, TOKYO (JP)

(21) Appl. No.: 17/998,247

(22) PCT Filed: Mar. 29, 2021
(86) PCT No.: PCT/JP2021/013326

§ 371 Date: Nov. 8, 2022

(30) Foreign Application Priority Data
May 20, 2020 (JP) 2020-088461

(51) Int. Cl. H04N 9/31; G02F 1/1335

(52) U.S. Cl. CPC H04N 9/3144; H04N 9/3108; G02F 1/133533

(57) ABSTRACT

A projection display apparatus (1) according to one embodiment of the present disclosure includes: a light source section (110); an image formation section (300) including a display device (310) that modulates light from the light source section on the basis of an input picture signal to generate a projection image; a projection section (400) that projects image light generated by the display device; an unnecessary light processing section (610) to which unnecessary light that does not contribute to a generation of the projection image is to be applied, out of light to be applied to the display device; and a heat circulation section (620) that spatially and mechanically couples the projection section and the unnecessary light processing section, or couples spatially and via a fluid the projection section and the unnecessary light processing section.

### TECHNICAL FIELD

The present disclosure relates, for example, to a projection display apparatus having a digital mirror device as a display device.

### BACKGROUND ART

For example, Patent Literature 1 discloses a projector that suppresses a variation in focal position of a projection optical unit associated with a temperature increase of a projection lens, by disposing, in a traveling direction of light outputted from a light source unit, a first lens group in which a focal position is changed to a position far from the projection optical unit in response to a temperature increase and a second lens group in which a focal position is changed to a position near to the projection optical unit in response to the temperature increase, and by further providing a heating unit that heats at least one of them and a control unit that controls the heating unit.

### CITATION LIST

### Patent Literature

Patent Literature 1: Japanese Unexamined Patent Application Publication No. 2011-209394

### SUMMARY OF THE INVENTION

Accordingly, an improvement of a quality of a projection image is demanded for a projection display apparatus.

It is desirable to provide a projection display apparatus that makes it possible to improve a quality of a projection image.

A projection display apparatus according to one embodiment of the present disclosure includes: a light source section; an image formation section including a display device that modulates light from the light source section on the basis of an input picture signal to generate a projection image; a projection section that projects image light generated by the display device; an unnecessary light processing section to which unnecessary light that does not contribute to a generation of the projection image is to be applied, out of light to be applied to the display device; and a heat circulation section that spatially and mechanically couples the projection section and the unnecessary light processing section, or couples spatially and via a fluid the projection section and the unnecessary light processing section.

In the projection display apparatus according to one embodiment of the present disclosure, the unnecessary light processing section to which the unnecessary light that does not contribute to the generation of the projection image is to be applied out of the light to be applied to the display device and the heat circulation section that spatially and mechanically couples or couples spatially and via the fluid the unnecessary light processing section and the projection section are provided. Thus, a temperature variation of the projection section is reduced.

### BRIEF DESCRIPTION OF THE DRAWINGS

FIG. 1 is a block diagram illustrating a schematic configuration of a projection display apparatus according to one embodiment of the present disclosure.

FIG. 2 is a diagram illustrating an example of an overall configuration of the projection display apparatus illustrated in FIG. 1 and a configuration of an optical system.

FIG. 3 is a diagram illustrating a configuration of a main part of the projection display apparatus illustrated in FIG. 1, etc.

FIG. 4 is a diagram illustrating an example of a structure of an unnecessary light heat circulation mechanism illustrated in FIG. 1 and a positional relationship between the unnecessary light heat circulation mechanism and a projection optical system.

FIG. 5 is a diagram illustrating another example of the structure of the unnecessary light heat circulation mechanism illustrated in FIG. 1.

FIG. 6 is a diagram illustrating another example of the structure of the unnecessary light heat circulation mechanism illustrated in FIG. 1.

FIG. 7A is a diagram for explaining an operation at the time of a bright image projection of the unnecessary light heat circulation mechanism illustrated in FIG. 1, etc.

FIG. 7B is a diagram for explaining an operation at the time of a dark image projection of the unnecessary light heat circulation mechanism illustrated in FIG. 1, etc.

FIG. 8 is a diagram illustrating an example of a configuration of an unnecessary light processing section in a projection display apparatus according to modification example 1 of the present disclosure.

FIG. 9 is a diagram illustrating an example of a configuration of an unnecessary light processing section in a projection display apparatus according to modification example 2 of the present disclosure.

FIG. 10 is a diagram illustrating a schematic configuration of a projection display apparatus according to modification example 3 of the present disclosure.

FIG. 11 is a diagram illustrating an example of an overall configuration of the projection display apparatus illustrated in FIG. 10 and a configuration of an optical system.

FIG. 12 is a diagram illustrating an example of a structure of an unnecessary light heat circulation mechanism illustrated in FIG. 10 and a positional relationship between the unnecessary light heat circulation mechanism and a projection optical system.

FIG. 13 is a perspective diagram illustrating an example of a structure of a heat circulation section illustrated in FIG. 12.

### MODES FOR CARRYING OUT THE INVENTION

Hereinafter, embodiments of the present disclosure will be described in detail with reference to the drawings. The following description is one specific example of the present disclosure, and the present disclosure is not limited to the following embodiments. In addition, the present disclosure is not limited to arrangement, dimensions, dimensional ratios, and the like of the constituent elements illustrated in the drawings. It is to be noted that the description is given in the following order.

1. Embodiment (an example of an image display unit that includes an unnecessary light heat circulation mechanism)

1-1. Configuration of Projection Display Apparatus

1-2. Operation of Unnecessary Light Heat Circulation Mechanism

1-3. Workings and Effects

### 2. Modification Examples

2-1. Modification Example 1 (another example of the unnecessary light heat circulation mechanism)

2-2. Modification Example 2 (another example of the unnecessary light heat circulation mechanism)

2-3. Modification Example 3 (an example of an image display unit that uses a transmission liquid crystal display device as a display device)

### 1. EMBODIMENT

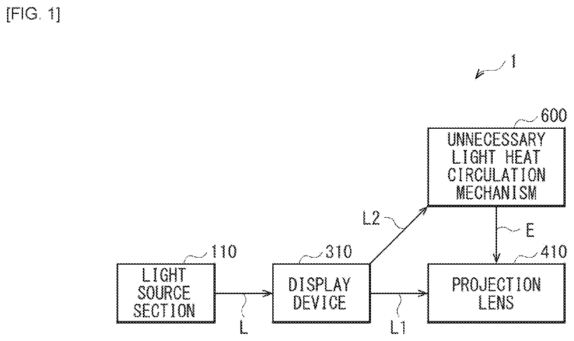

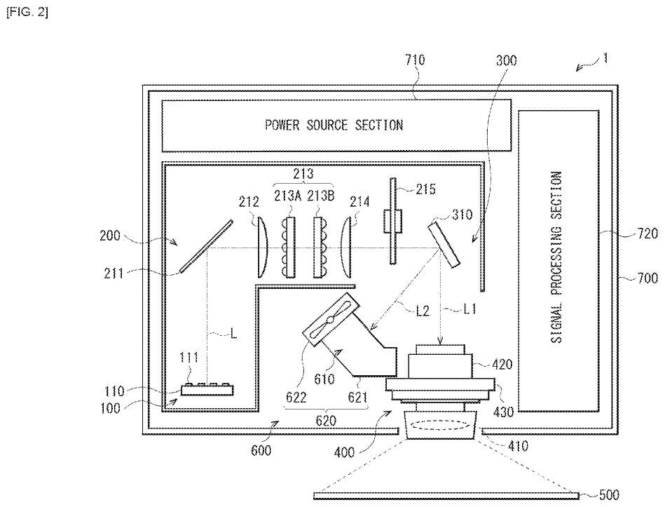

FIG. 1 illustrates a schematic configuration of a projection display apparatus (a projection display apparatus 1) according to one embodiment of the present disclosure. The projection display apparatus 1 of the present embodiment uses a digital micro-mirror device (DMD) as a display device 310. The projection display apparatus 1 includes a light source section 110, the display device 310, a projection lens 410, and an unnecessary light heat circulation mechanism 600, and the unnecessary light heat circulation mechanism 600 includes, for example, an unnecessary light processing section 610 and a heat circulation section 620 (see, e.g., FIG. 2). In the present embodiment, out of light L applied to the display device 310, light (unnecessary light) L2 that does not contribute to the generation of a projection image is reflected toward the unnecessary light processing section 610, and the unnecessary light L2 applied to the unnecessary light processing section 610 is converted into a heat energy E. The heat energy E generated in the unnecessary light processing section 610 is made to flow to the projection lens 410 through the heat circulation section 620.

### 1-1. Configuration of Projection Display Apparatus

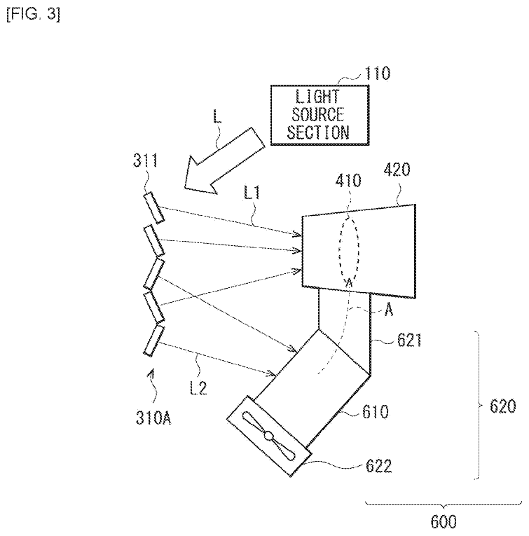

FIG. 2 illustrates an example of an overall configuration of the projection display apparatus 1 illustrated in FIG. 1 and a configuration of an optical system. FIG. 3 schematically illustrates a configuration of a main part of the projection display apparatus illustrated in FIGS. 1 and 2. The projection display apparatus 1 includes a light source unit 100 that includes a light source section 110, an illumination optical system 200, an image formation section 300 that includes the display device 310, and a projection optical system 400 that includes the projection lens 410, in this order. The light source unit 100, the illumination optical system 200, the image formation section 300, and the projection optical system 400 are contained, for example, in a housing 700, and the housing 700 is further provided with, for example, a power source section 710 and a signal processing section 720.

The light source unit 100 includes the light source section 110 as described above. The light source section 110 has, for example, one or a plurality of light sources 111. The light source 111 is a solid-state light source that outputs light in a predetermined wavelength range. As the light source 111, for example, it is possible to use a semiconductor laser (Laser Diode: LD). Besides, a light emitting diode (Light Emitting Diode: LED) may be used.

In addition to the light source section 110 described above, the light source unit 100 includes, for example, a light source driving section, a light source driver that drives the light source section 110, and a current value setting section that sets a current value upon driving the light source section 110, although they are not illustrated. The light source driver generates a current having a current value set by the current value setting section in synchronization with a signal inputted from the light source driving section, for example, on the basis of electric power supplied from the power source section 710. The generated current is supplied to the light source section 110.

The illumination optical system 200 has, for example, a reflection mirror 211, a lens 212, a fly-eye lens 213 (213A and 213B), a lens 214, and a color wheel 215, from a position close to the light source unit 100.

The reflection mirror 211 reflects the light L outputted from the light source unit 100 toward the lens 212. The lens 212 outputs the light L entered from the reflection mirror 211 toward the fly-eye lens 213. The fly-eye lens 213 (213A and 213B) is intended to homogenize an illuminance distribution of the light L outputted from the lens 212. The lens 214 collects the light having transmitted through the fly-eye lens 213B in a predetermined spot diameter and causes the light to enter the color wheel 215. The color wheel 215 converts the white light L outputted from the light source unit 100 into pieces of light of respective colors in time series.

The image formation section 300 has the display device 310 as described above. The display device 310 modulates the light L outputted from the color wheel 215 on the basis of an inputted picture signal to generate a projection image, and is configured by a digital micro-mirror device 310A as described above.

The digital micro-mirror device 310A has a configuration in which, for example, a mirror 311 having a high reflectance is arranged for each pixel two-dimensionally arranged in a matrix, and allows for a projection of various images by an inclination of the mirror 311 and a control of the light source unit 100. As will be described in detail later, in the present embodiment, as illustrated in FIG. 3, out of the light L outputted from the color wheel 215 and applied to the digital micro-mirror device 310A, light (projection image light) L1 that generates the projection image is reflected toward the projection optical system 400 by the mirror 311 of the corresponding pixel, and the unnecessary light L2 that does not contribute to the generation of the projection image is reflected toward the unnecessary light processing section 610 by the mirror 311 of the corresponding pixel.

The projection optical system 400 enlarges the projection image light L1 that has entered from the image formation section 300 and projects the projection image light L1 onto a screen 500 or the like, and has, for example, one or a plurality of projection lenses 410. The projection lens 410 is, for example, held by a cylinder 420 and further supported by a flange 430. The flange 430 is fastened to the housing 700 by, for example, an unillustrated structure. Thus, the projection lens 410 is fixed to the housing 700 via the flange 430.

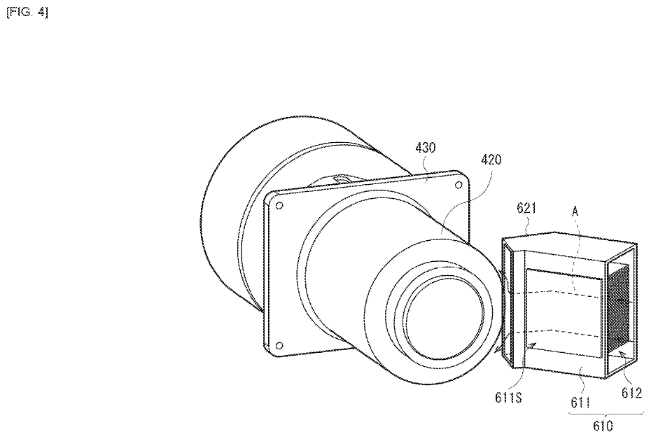

The unnecessary light heat circulation mechanism 600 has the unnecessary light processing section 610 and the heat circulation section 620 as described above. FIG. 4 illustrates an example of a structure of the unnecessary light processing section 610 and a positional relationship between the unnecessary light processing section 610 and the projection optical system 400.

The unnecessary light processing section 610 has, for example, an unnecessary light illumination section 611 having a face (an illumination face 611S) to which the unnecessary light L2 is to be applied, and a plurality of fins 612 that is provided on a back surface side of the illumination face 611S of the unnecessary light illumination section 611 and releases a heat generated at the unnecessary light illumination section 611 by the application of the unnecessary light L2. The unnecessary light illumination section 611 has, for example, a rectangular cylindrical shape so as to surround the plurality of fins 612. The unnecessary light illumination section 611 may be formed using, for example, a heat sink. A surface of the heat sink has preferably been subjected to a blackening process, for example, in order to suppress a reflection of the unnecessary light L2 inside the housing 70 and to provide an adequate heat release.

The heat circulation section 620 includes a duct 621 that spatially and mechanically couples the unnecessary light processing section 610 and the projection optical system 400, and an air blower 622 that causes air Aw warmed in the vicinity of the plurality of fins 612 to flow to the cylinder 420 through the duct 621. Specifically, one end of the duct 621 is coupled to the unnecessary light illumination section 611 that surrounds the plurality of fins 612, and the other end is so disposed as to face a portion, of the cylinder 420 that holds the projection lens 410, that is highly sensitive to temperature characteristics of the projection lens 410, for example. The air blower 622 is disposed on an opposite side of a side, of the plurality of fins 612, on which the duct 621 is coupled, for example.

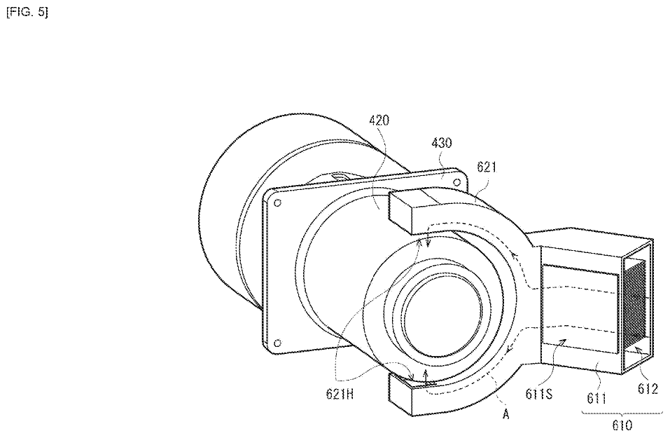

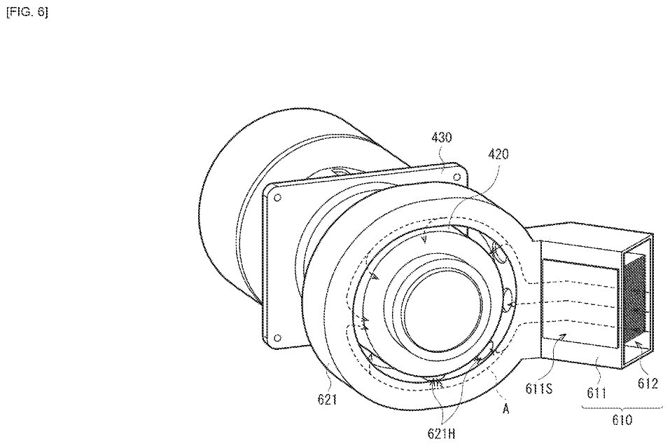

It should be noted that a shape of the duct 621 is not limited thereto. For example, as illustrated in FIGS. 5 and 6, the duct 621 may be so extended as to surround the cylinder 420, and an opening 621H may be provided at a predetermined position. This causes the air A warmed or cooled upon passing through the plurality of fins 612 to be blown at a desired position of the cylinder 420.

The power source section 710 has, for example, a power source circuit or the like of the light source section 110 and the mirror 311 of each pixel of the digital micro-mirror device 310A.

The signal processing section 720 has, for example, an image processing section, a mirror driving section, a projection optical system driving section, a control section, and the like, although not illustrated.

The image processing section acquires an image signal inputted from the outside and, for example, determines an image size, determines the resolution, determines whether an image is a still image or a moving image, etc. In a case where the image is the moving image, the image processing section also determines a property of image data such as a frame rate, etc. In addition, in a case where the resolution of the acquired image signal is different from the display resolution of the digital micro-mirror device 310A, the image processing section performs a resolution conversion process. The image processing section expands an image having been subjected to each of these processes in a frame memory for each frame, and outputs, to the mirror driving section, an image of each frame expanded in the frame memory as a display signal.

The mirror driving section drives each mirror 311 of the digital micro-mirror device 310A. By the driving of the mirror driving section, the inclination and the like of each mirror 311 is controlled to form an image.

The projection optical system driving section includes a motor that drives a projection lens disposed in the projection optical system 400. The projection optical system driving section, for example, drives the projection optical system 400 in accordance with the control of the control section, and for example, performs zooming adjustment, focusing adjustment, diaphragm adjustment, and the like.

The control section controls, for example, the light source driving section, the image processing section, the mirror driving section, and the projection optical system driving section.

### 1-2. Operation of Unnecessary Light Heat Circulation Mechanism

A typical projection display apparatus is provided with a projection lens as with the projection display apparatus 1 of the present embodiment, and a large-screen display is achieved by magnifying and forming, by the projection lens, an image created by a display device smaller than a size of an image to be projected. In the projection display apparatus, precisely matching an image formation point of the projection lens to a screen display device such as a screen influences a quality of an image to be projected (a projection image).

However, in general, an image formation point position of the projection lens has temperature characteristics due to the expansion and contraction of the lens, temperature characteristics of optical physical properties of the lens, the expansion and contraction of the cylinder structure body that holds the lens, and the like, and variations in the image formation point position occur depending on the projection image.

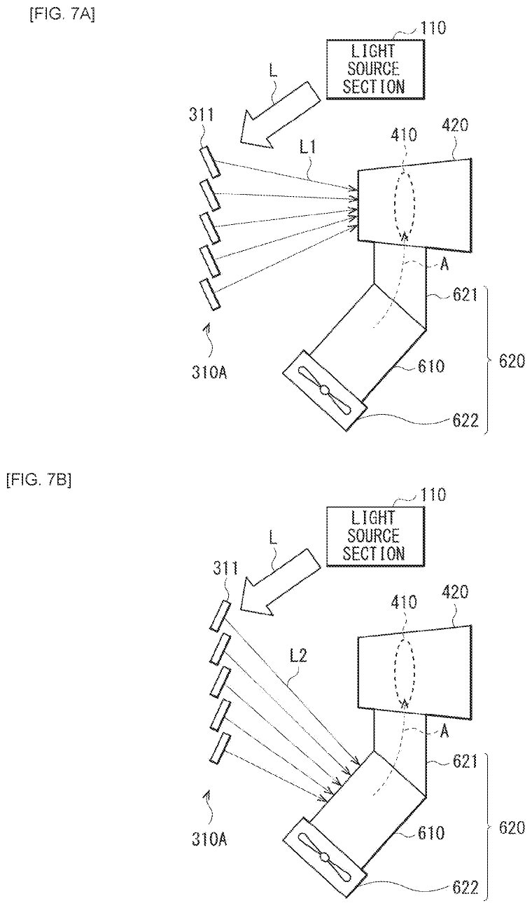

FIG. 7A schematically illustrates an operation of the digital micro-mirror device 310A and the unnecessary light heat circulation mechanism 600 at the time of bright image projection. FIG. 7B schematically illustrates an operation of the digital micro-mirror device 310A and the unnecessary light heat circulation mechanism 600 at the time of dark image projection.

At the time of bright image projection, as illustrated in FIG. 7A, much of the light L applied to the digital micro-mirror device 310A from the light source section 110 through the illumination optical system 200 is reflected toward the projection lens 410 by the mirror 311 as the projection image light L1. Accordingly, a temperature of the projection lens 410 and the cylinder 420 holding the same becomes high, and the image formation point position varies. On the other hand, at the time of bright image projection, the unnecessary light processing section 610 remains in a low temperature state because there are no or fewer unnecessary light L2. The air blower 622 configuring the heat circulation section 620 blows the surrounding air A to the unnecessary light processing section 610. The air A blown to the unnecessary light processing section 610 is cooled by passing through the plurality of fins 612 disposed inside the unnecessary light illumination section 611, or flows at a normal temperature without being heated. This relatively low temperature air Ac is blown through the duct 621 to a portion of the cylinder 420 which is in a high temperature state. As a result, the cylinder 420 and the projection lens 410 held thereby are cooled.

At the time of dark image projection, as illustrated in FIG. 7B, much of the light L applied to the digital micro-mirror device 310A from the light source section 110 through the illumination optical system 200 is reflected toward the unnecessary light processing section 610 by the mirror 311 as the unnecessary light L2. Accordingly, the unnecessary light processing section 610 is heated to a high temperature. On the other hand, at the time of dark image projection, because there is no or fewer projection image light L1, the projection lens 410 and the cylinder 420 holding the same become a low temperature state. The air blower 622 configuring the heat circulation section 620 blows the surrounding air A to the unnecessary light processing section 610. The air A blown to the unnecessary light processing section 610 is warmed by passing through the plurality of fins 612 disposed inside the unnecessary light illumination section 611. The warmed air Aw is blown through the duct 621 to a portion of the cylinder 420 which is in a low temperature state. As a result, the cylinder 420 and the projection lens 410 held thereby are warmed.

Thus, the projection display apparatus 1 of the present embodiment blows the air Ac cooled in the unnecessary light processing section 610 upon the bright image projection and the air Aw warmed in the unnecessary light processing section 610 upon the dark image projection to the cylinder 420 that holds the projection lens 410. As a result, variations in the temperature of the projection lens 410 and the cylinder 420 holding the same are reduced, and the variations in the image formation point position are suppressed.

Further, by designing the unnecessary light heat circulation mechanism 600 such that an efficiency of the projection image light L1 that enters the projection lens 410 is converted into a temperature becomes equivalent to a heat conversion efficiency from the unnecessary light processing section 610 to the cylinder 420 and the projection lens 410 held thereby through the heat circulation section 620, the same amount of heat is constantly inputted to the projection lens 410 regardless of blight or dark of the image to be projected onto the screen 500 or the like. As a result, it is possible to allow a temperature of the projection lens 410 to be kept substantially constant, and to improve a focusing performance of the projection display apparatus 1.

It should be noted that a method of adjusting the heat conversion efficiency from the unnecessary light L2 to the projection lens 410 includes, for example, the Scripture of an amount of air blown by the fan, a control of an optical absorptance of the unnecessary light processing section 610, a control of the heat transfer rate from the unnecessary light processing section 610 to the air (for example, a change in the surface area of the fins 612), and the like.

### 1-3. Workings and Effects

In the projection display apparatus 1 of the present embodiment, the unnecessary light heat circulation mechanism 600 having the unnecessary light processing section 610 to which the unnecessary light L2 that does not contribute to the generation of the projection image is to be applied and the heat circulation section 620 that spatially and mechanically couples or couples spatially and via a fluid the projection optical system 400 and the unnecessary light processing section 610. Thus, a temperature variation of the projection lens 410 and the cylinder 420 holding the same is reduced. This will be described below.

As described above, a typical projection display apparatus is provided with a projection lens, and a large-screen display is achieved by magnifying and forming, by the projection lens, an image created by a display device smaller than a size of an image to be projected. In the projection display apparatus, precisely matching an image formation point of the projection lens to a screen display device such as a screen influences a quality of an image to be projected (a projection image). For example, in a case where the image formation point of the projection lens does not correspond to a position of the screen, a blurry image is displayed on the screen.

However, in general, an image formation point position of the projection lens has temperature characteristics due to the expansion and contraction of the lens, temperature characteristics of optical physical properties of the lens, the expansion and contraction of the cylinder structure body that holds the lens, and the like. Accordingly, even if a focal point is adjusted in a projection image and a position of the image formation point of the projection lens and a position of the screen are matched, it is difficult for the image formation point to maintain an optimally adjusted state constantly because the variations in the image formation point position occur by the projection image.

For example, in the projection display apparatus, in a case where an image to be projected is dark, an image that enters the projection lens is also dark, resulting in a state in which a light amount is small. On the other hand, in a case where an image to be projected is bright, an image that enters the projection lens is also bright, resulting in a state in which a light amount is large. That is, due to blight or dark of the image to be projected, the amount of light that enters the projection lens changes in real time, and the image formation point of the projection lens also changes in real time.

Accordingly, even if a user adjusts a focal point in a projection image and adjusts the position of the screen and the image formation point to coincide, the changes in bright or dark of the projection image cause the variations in the image formation point, making it difficult to see constantly a sharp projection image in which the position of the screen and the image formation point coincide.

As a method of suppressing the variations in the image formation point of the projection lens due to the change in the amount of light that enters the projection lens as described above, as described previously, a method has been reported that suppresses a variation in focal position of a projection optical unit, by disposing a plurality of lens groups in a traveling direction of light outputted from a light source unit and by further providing a heating unit that heats at least any of the lens groups and a control unit that controls the heating unit.

Besides, a structure has been reported that an aberration correcting lens is cooled by cooling the inside of a cylinder that holds the lens to suppress a change in an aberration of a projection lens caused by a temperature increase and to suppress a decrease in quality of a projection image. In addition, a structure has been reported that a plurality of temperature measurement devices and temperature control devices are provided in a plane direction (a direction vertical to an optical axis of an image to be projected) to eliminate an uneven temperature in the plane direction and suppress a decrease in quality of a projection image.

However, in the method described above, it is necessary to dispose the temperature sensor for obtaining the temperature information and the control device that controls the heating mechanism and the cooling mechanism on the basis of the information from the temperature sensor in the housing, and an increase in cost with an increase in the number of components and an increase in a size of an apparatus occurs as issues. In addition, because a cooling mechanism is controlled after the temperature information is acquired, a time lag occurs until the cooling mechanism becomes effective, and it is difficult to accurately correct the image formation point of the projection lens that varies in real time.

In contrast, in the projection display apparatus 1 of the present embodiment, the unnecessary light heat circulation mechanism 600 having the unnecessary light processing section 610 and the heat circulation section 620 is provided, and, for example, at the time of the bright image projection, the projection lens 410 that has become the high temperature state due to the entry of a large amount of projection image light L1 and the cylinder 420 that holds the same are blown with the air Ac that is cooled by passing through the unnecessary light processing section 610 in the low temperature state to cool the projection lens 410 and the cylinder 420 that holds the same. In addition, at the time of dark image projection, the air Aw warmed in the unnecessary light illumination section 611 that has become the high temperature state by the application of a large amount of unnecessary light L2 is blown to the projection lens 410 in the low temperature state and the cylinder 420 that holds the same to warm the projection lens 410 and the cylinder 420 that holds the same. Thus, the temperature variation of the projection lens 410 and the cylinder 420 due to the changes in bright or dark of the projection image is reduced.

As described above, in the projection display apparatus 1 of the present embodiment, it is possible to suppress the variation of the image formation point and improve the quality of the projection image.

Further, in the projection display apparatus 1 of the present embodiment, it is possible to reduce the size of the projection display apparatus 1 as compared with a case in which the temperature sensor, the control device, and the like described above are provided. Further, in the projection display apparatus 1 of the present embodiment, because there is no time lag from the acquisition of the temperature information until the cooling mechanism becomes effective as described above, it is possible to improve the accuracy of the temperature control of the projection lens 410.

Next, modification examples (modification examples 1 to 3) of the present disclosure will be described. Hereinafter, the similar components to those of the embodiment described above are denoted by the same reference numerals, and description thereof is omitted as appropriate.

### 2. MODIFICATION EXAMPLES

### 2-1. Modification Example 1

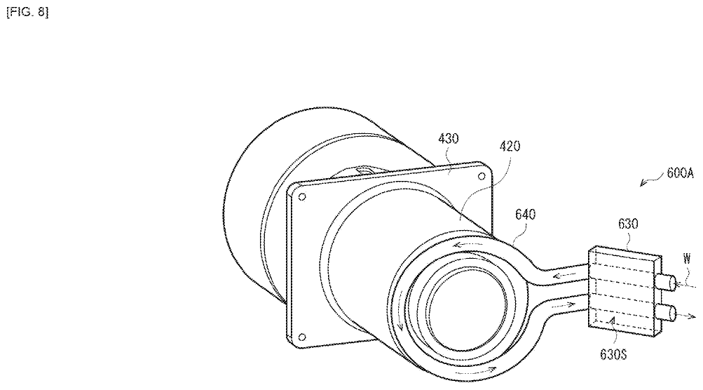

FIG. 8 illustrates another example of a configuration of an unnecessary light heat circulation mechanism 600A as a modification example (modification example 1) of the projection display apparatus 1 illustrated in FIG. 1, etc. In the above embodiment, an example is illustrated in which the unnecessary light heat circulation mechanism 600 is configured using the unnecessary light processing section 610 configured by the unnecessary light illumination section 611 and the plurality of fins 612 and the heat circulation section 620 configured by the duct 621 and the air blower 622, but the configuration of the unnecessary light heat circulation mechanism 600 is not limited thereto. The unnecessary light heat circulation mechanism 600A of the present modification example is configured by using a water circulation circuit.

In the unnecessary light heat circulation mechanism 600A, the unnecessary light processing section is configured by, for example, a heat sink 630 having a predetermined thickness. The heat circulation section is configured by, for example, a tube 640, a refrigerant W such as, for example, water, and a transmission section such as, for example, a pump, that circulates the refrigerant W in the tube 640, although not illustrated. For example, one face of the heat sink 630 serves as an illumination face 630S of the unnecessary light L2, and two continuous tubes 640 pass through the inside. The tube 640 is, for example, coupled to the transmission section at both ends thereof, and is so disposed as to surround, for example, the periphery of the cylinder 420 at a point where it penetrates the heat sink 630.

Thus, for example, at the time of bright image projection, the projection lens 410 and the cylinder 420 that holds the same are cooled by circulating the refrigerant W cooled in the heat sink 630 around the projection lens 410 that has become the high temperature state by the entry of a large amount of projection image light L1 and the cylinder 420 that holds the same. The refrigerant W warmed by circulating around the projection lens 410 in the high temperature state and the cylinder 420 that holds the same is cooled further by passing through the heat sink 630 again and returns to the transmission section and is again delivered to the projection lens 410 and the cylinder 420 that holds the same. In addition, at the time of dark image projection, the projection lens 410 and the cylinder 420 that holds the same are warmed by circulating the refrigerant W warmed upon passing through the heat sink 630, which has become the high temperature state by the application of a large amount of unnecessary light L2, around the projection lens 410 in the low temperature state and the cylinder 420 that holds the same.

As described above, even in a case where the unnecessary light heat circulation mechanism 600A is configured using the water circulation passage, it is possible to reduce the temperature variation of the projection lens 410 and the cylinder 420 due to the changes in bright or dark of the projection image and to suppress the variation in the image formation point, as with the above-described embodiment.

### 2-2. Modification Example 2

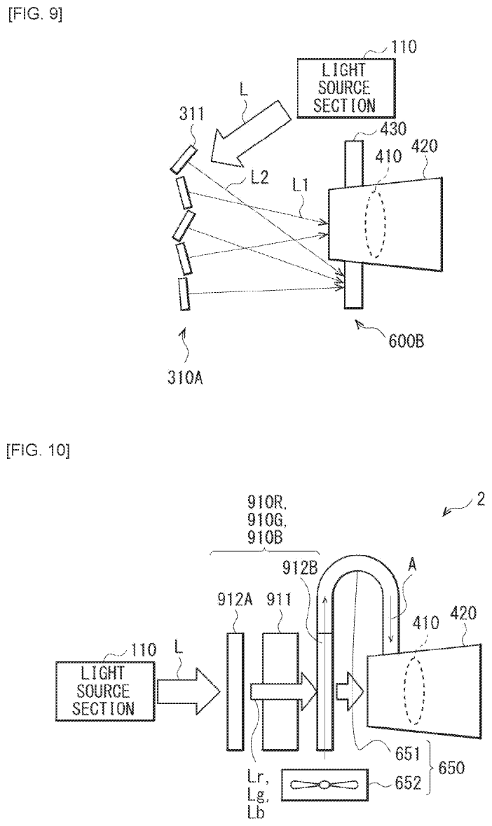

FIG. 9 illustrates another example of a configuration of an unnecessary light heat circulation mechanism 600B as a modification example (modification example 2) of the projection display apparatus 1 illustrated in FIG. 1, etc. The unnecessary light heat circulation mechanism 600B of the present modification example uses a portion of the projection optical system 400, specifically a flange 430, as the unnecessary light processing section and the heat circulation section.

In the present modification example, the flange 430 serves both as the unnecessary light processing section and the heat circulation section. As a result, for example, at the time of bright image projection, the heat generated at the projection lens 410 by the entry of a large amount of projection image light L1 is released at the flange 430 through the cylinder 420. At the time of dark image projection, the flange 430 becomes the high temperature state by the application of much of the unnecessary light L2. This heat is conducted to the projection lens 410 through the cylinder 420.

Thus, even in a case where a portion of the projection optical system 400 (e.g., the flange 430) is used as the unnecessary light processing section and the heat circulation section, it is possible to reduce the temperature variation of the projection lens 410 and the cylinder 420 due to the changes in bright or dark of the projection image and to suppress the variation in the image formation point, as with the above-described embodiment.

### 2-3. Modification Example 3

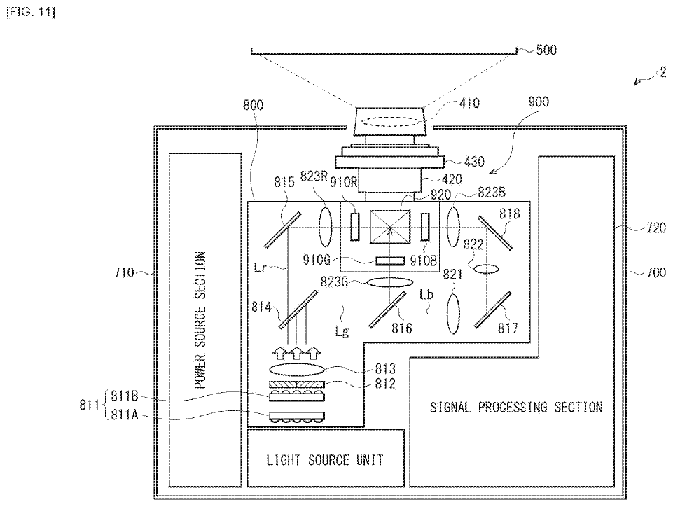

FIG. 10 illustrates a schematic configuration of a projection display apparatus (a projection display apparatus 2) according to modification example 3 of the present disclosure. FIG. 11 illustrates an example of an overall configuration of the projection display apparatus 2 illustrated in FIG. 10 and a configuration of an optical system. The projection display apparatus 2 of the present modification example differs from the above embodiment in that a transmission liquid crystal panel is used as a display device 910.

The projection display apparatus 2 is an projection display apparatus of a transmission 3 LCD type that performs a light modulation by a transmission liquid crystal panel, and includes the light source unit 100 that includes the light source section 110, an illumination optical system 800, an image formation section 900 that includes transmission liquid crystal panels 910R, 910G, and 910B as the display device 910, and a projection optical system 400 that includes a projection lens 410, in this order. The light source unit 100, the illumination optical system 800, the image formation section 900, and the projection optical system 400 are contained, for example, in a housing 700. In the housing 700, a power source section 710 and a signal processing section 720, for example, are further provided as with the projection display apparatus 1.

The illumination optical system 800 includes, for example, an integrator device 811, a polarization conversion device 812, and a condenser lens 813. The integrator device 811 includes a first fly-eye lens 811A having a plurality of micro-lenses arranged two-dimensionally and a second fly-eye lens 811B having a plurality of micro-lenses arranged so as to correspond one by one to each micro-lens.

The light (parallel light) that enters the integrator device 811 from the light source unit 100 is divided into a plurality of light beams by the micro-lenses of the first fly-eye lens 811A, and forms an image on each corresponding micro-lens in the second fly-eye lens 811B. Each micro-lens of the second fly-eye lens 811B functions as a secondary light source, and irradiates the polarization conversion device 812 with a plurality of pieces of parallel light having a uniform luminance as incident light.

The integrator device 811 as a whole has a function of arranging the incident light applied from the light source unit 100 to the polarization conversion device 812 into a uniform luminance distribution.

The polarization conversion device 812 has a function of aligning a polarization state of the incident light that enters through the integrator device 811 and the like. The polarization conversion device 812 outputs output light that contains blue light Lb, green light Lg and red light Lr, for example, via a condenser lens 183.

The illumination optical system 800 further includes a dichroic mirror 814, a mirror 815, a dichroic mirror 816, a mirror 817, a mirror 818, a relay lens 821, a relay lens 822, a field lens 823R, a field lens 823G, and a field lens 823B.

The dichroic mirror 814 and the dichroic mirror 816 selectively reflect color light in a predetermined wavelength range and transmit light in any other wavelength range. For example, the dichroic mirror 814 selectively reflects the green light Lg and the blue light Lb. The dichroic mirror 816 selectively reflects the green light Lg, out of the green light Lg and the blue light Lb reflected at the dichroic mirror 814. The remaining blue light Lb is transmitted through the dichroic mirror 816. As a result, the light outputted from the light source unit 100 is separated into a plurality of pieces of color light of different colors.

The red light Lr dropped by the dichroic mirror 814 is reflected by the mirror 815, collimated by passing through the field lens 823R, and then enters the liquid crystal panel 910R for modulation of the red light Lr. After being collimated by passing through the field lens 623G, the green light Lg enters the liquid crystal panel 910G for modulation of the green light Lg. The blue light Lb is reflected by the mirror 817 through the relay lens 821, and further by the mirror 818 through the relay lens 822. The blue light Lb reflected by the mirror 818 is collimated by passing through the field lens 823B, and then enters the liquid crystal panel 9101B for modulation of the blue light Lb.

The image formation section 900 has liquid crystal panels 910R, 910G, and 910B and a dichroic prism 920.

The liquid crystal panels 910R, 910G, 910B are electrically coupled to an unillustrated signal source (for example, PC or the like) that supplies an image signal containing image information. The liquid crystal panels 910R, 910G, and 910B modulate the incident light on a pixel-by-pixel basis on the basis of the supplied image signals of respective colors to respectively generate a red image, a green image, and a blue image. The modulated pieces of light of respective colors (formed projection images) are synthesized by entering the dichroic prism 920. The dichroic prism 920 superimposes and combines the pieces of light of respective colors that have entered from the three directions, and outputs the superimposed light toward the projection optical system 400.

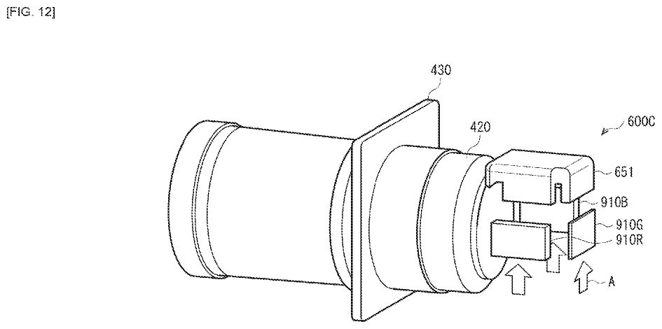

FIG. 12 illustrates an example of a structure of the unnecessary light heat circulation mechanism 600C and a positional relationship between the unnecessary light heat circulation mechanism 600C and the projection optical system 400 in the present modification example. In the unnecessary light heat circulation mechanism 600C, the liquid crystal panels 910R, 910G, and 910B also serve as an unnecessary light processing section. Each liquid crystal panel 910R, 910G, and 910B has a liquid crystal layer 911 and polarization plates 912A and 912B with the liquid crystal layer 911 interposed therebetween, and the unnecessary light L2 that does not contribute to the generation of the projection image is absorbed by the polarization plate 912B.

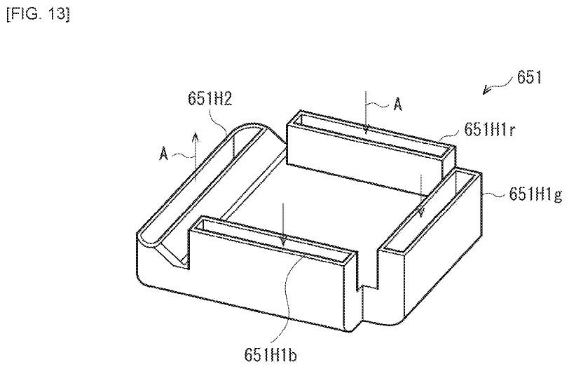

The heat circulation section 650 is configured by, for example, a duct 651 and an air blower 652. The duct 651 has, for example, as illustrated in FIGS. 12 and 13, three openings 651H1r, 651H1g, and 651H1b serving as intake ports of the air A and one opening 651H2 serving as a blow port, and respective openings 651H1r, 651H1g, and 651H1b are respectively disposed above the corresponding liquid crystal panels 910R, 910G, and 910B, and the opening 651H2 is so disposed as to face the cylinder 420. The air blower 652 is disposed, for example, below the liquid crystal panels 910R, 910G, and 910B.

As a result, for example, at the time of bright image projection, much of respective pieces of color light Lr, Lg, and Lb that have entered the liquid crystal panels 910R, 910G, and 910B enter the projection lens 410 as the projection image light L1 through the dichroic prism 920, and the projection lens 410 and the cylinder 420 that holds the same become the high temperature state. On the other hand, because the low temperature state of the liquid crystal panels 910R, 910G, and 910B is maintained, the air A blown to the liquid crystal panels 910R, 910G, and 910B by the air blower 652 is cooled. The cooled air Ac is blown from the respective openings 651H1r, 651H1g, and 651H1b through the duct 621 from the opening 651H2 to the cylinder 420 to cool the cylinder 420 and the projection lens 410 held thereby.

At the time of dark image projection, much of respective pieces of color light Lr, Lg, and Lb that have entered the liquid crystal panels 910R, 910G, and 910B are absorbed by the polarization plate 912B as the unnecessary light L2. Accordingly, the polarization plate 912B is heated to a high temperature. On the other hand, because there are no or fewer projection image light L1, the projection lens 410 and the cylinder 420 that holds the same are in the low temperature state. The air A blown to the liquid crystal panels 910R, 910G, and 910B by the air blower 652 is warmed by the polarization plate 912B in the high temperature state. The warmed air Aw is blown from the respective openings 651H1r, 651H1g, and 651H1b through the duct 621 from the opening 651H2 to the cylinder 420 to warm the cylinder 420 and the projection lens 410 held thereby.

As described above, in the present technology, even in a case where the transmission liquid crystal panels 910R, 910G, and 910B are used as the display device 910, it is possible to reduce the temperature variation of the projection lens 410 and the cylinder 420 due to the changes in bright or dark of the projection image, and to suppress the variation in the image formation point.

It should be noted that, in the present modification example, an example using the transmission liquid crystal panels 910R, 910G, and 910B has been described, but even in a case where, for example, a reflection liquid crystal panel is used, it is possible to achieve similar effects by providing a mechanism that circulates, to the projection lens 410, the unnecessary light emitted to a portion other than the projection lens 410 when a dark image is projected, for example, such as a duct 651.

Although the present technology has been described with reference to the embodiment and the modification examples 1 to 3, the present technology is not limited to the embodiment and the like, and various modifications can be made.

Further, in the above embodiment and the like, the optical members configuring the projection display apparatuses 1 and 2 have been specifically described, but it is not necessary to provide all of the optical members, and other optical members may be further provided.

It is to be noted that the effects described in the present specification are merely examples, but not limited. Moreover, other effects may be included.

It should be noted that it is also possible to configure the present disclosure as follows. According to the present technology of the following configuration, the unnecessary light processing section to which the unnecessary light that does not contribute to the generation of the projection image is to be applied out of the light to be applied to the display device and the heat circulation section that spatially and mechanically couples or couples spatially and via the fluid the unnecessary light processing section and the projection section are provided. Thus, a temperature variation of the projection section is reduced. Hence, it is possible to improve the quality of the projection image.

(1)

A projection display apparatus including:

a light source section;

an image formation section including a display device that modulates light from the light source section on the basis of an input picture signal to generate a projection image;

a projection section that projects image light generated by the display device;

an unnecessary light processing section to which unnecessary light that does not contribute to a generation of the projection image is to be applied, out of light to be applied to the display device; and

a heat circulation section that spatially and mechanically couples the projection section and the unnecessary light processing section, or couples spatially and via a fluid the projection section and the unnecessary light processing section.

(2)

The projection display apparatus according to (1), in which the heat circulation section circulates a heat energy of the unnecessary light to the projection section by using the unnecessary light processing section as a heat source.

(3)

The projection display apparatus according to (2), in which the heat circulation section circulates a heat, generated at the unnecessary light processing section by the application of the unnecessary light, to the projection section by blowing of air.

(4)

The projection display apparatus according to (2), in which the heat circulation section circulates a heat, generated at the unnecessary light processing section by the application of the unnecessary light, to the projection section by a flow of water.

(5)

The projection display apparatus according to any one of (2) to (4), in which

the projection section includes one or more projection lenses, a cylinder that holds the projection lens, and a supporting section that supports the cylinder, and

the projection section also serves as the unnecessary light processing section and the heat circulation section.

(6)

The projection display apparatus according to any one of (1) to (5), in which the unnecessary light processing section has an unnecessary light illumination section to which the unnecessary light is to be applied, and a heat releasing section that releases a heat generated by the application of the unnecessary light to the unnecessary light illumination section.

(7)

The projection display apparatus according to (6), in which the unnecessary light illumination section is configured by a heat sink that has a surface having been subjected to a blackening process.

(8)

The projection display apparatus according to (6) or (7), in which the heat releasing section is configured by a plurality of fins.

(9)

The projection display apparatus according to any one of (6) to (8), in which the heat circulation section includes a duct that spatially and mechanically couples the heat releasing section and the projection section, and an air blower disposed on the other end side that is on an opposite side of one end side of the heat releasing section to which the duct is coupled.

(10)

The projection display apparatus according to any one of (6) to (9), in which the heat circulation section includes a flow passage that spatially and mechanically couples the heat releasing section and the projection section, and a refrigerant that circulates inside the flow passage.

(11)

The projection display apparatus according to any one of (1) to (10), in which the display device includes a digital mirror device.

(12)

The projection display apparatus according to any one of (1) to (11), in which the display device includes a transmission liquid crystal display device.

(13)

The projection display apparatus according to (12), in which

the transmission liquid crystal display device includes a liquid crystal layer, and a pair of polarization plates that interpose the liquid crystal layer, and

one of the pair of polarization plates serves as the unnecessary light processing section.

The present application claims the benefit of Japanese Priority Patent Application JP2020-088461 filed with the Japan Patent Office on May 20, 2020, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A projection display apparatus comprising:
a light source section;
an image formation section including a display device that modulates light from the light source section on a basis of an input picture signal to generate a projection image;
a projection section that projects image light generated by the display device;
an unnecessary light processing section to which unnecessary light that does not contribute to a generation of the projection image is to be applied, out of light to be applied to the display device; and
a heat circulation section that spatially and mechanically couples the projection section and the unnecessary light processing section, or couples spatially and via a fluid the projection section and the unnecessary light processing section.

2. The projection display apparatus according to claim 1, wherein the heat circulation section circulates a heat energy of the unnecessary light to the projection section by using the unnecessary light processing section as a heat source.

3. The projection display apparatus according to claim 2, wherein the heat circulation section circulates a heat, generated at the unnecessary light processing section by the application of the unnecessary light, to the projection section by blowing of air.

4. The projection display apparatus according to claim 2, wherein the heat circulation section circulates a heat, generated at the unnecessary light processing section by the application of the unnecessary light, to the projection section by a flow of water.

5. The projection display apparatus according to claim 2, wherein
the projection section includes one or more projection lenses, a cylinder that holds the projection lens, and a supporting section that supports the cylinder, and
the projection section also serves as the unnecessary light processing section and the heat circulation section.

6. The projection display apparatus according to claim 1, wherein the unnecessary light processing section has an unnecessary light illumination section to which the unnecessary light is to be applied, and a heat releasing section that releases a heat generated by the application of the unnecessary light to the unnecessary light illumination section.

7. The projection display apparatus according to claim 6, wherein the unnecessary light illumination section is configured by a heat sink that has a surface having been subjected to a blackening process.

8. The projection display apparatus according to claim 6, wherein the heat releasing section is configured by a plurality of fins.

9. The projection display apparatus according to claim 6, wherein the heat circulation section includes a duct that spatially and mechanically couples the heat releasing section and the projection section, and an air blower disposed on the other end side that is on an opposite side of one end side of the heat releasing section to which the duct is coupled.

10. The projection display apparatus according to claim 6, wherein the heat circulation section includes a flow passage that spatially and mechanically couples the heat releasing section and the projection section, and a refrigerant that circulates inside the flow passage.

11. The projection display apparatus according to claim 1, wherein the display device comprises a digital mirror device.

12. The projection display apparatus according to claim 1, wherein the display device comprises a transmission liquid crystal display device.

13. The projection display apparatus according to claim 12, wherein
the transmission liquid crystal display device includes a liquid crystal layer, and a pair of polarization plates that interpose the liquid crystal layer, and
one of the pair of polarization plates serves as the unnecessary light processing section.
